(19) United States
(12) Patent Application Publication
(10) Pub. No.: US 2002/0043767 A1
(43) Pub. Date: Apr. 18, 2002

(54) Surface and intermediate sealing systems for waste tips and for safeguarding contaminated sites

(75) Inventor: Lutz Bilke, Sangerhausen (DE)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: Wishbone Investments Limited

(21) Appl. No.: 09/759,592

(22) Filed: Jan. 12, 2001

(30) Foreign Application Priority Data
Jan. 12, 2000 (DE) 10001276.0

(51) Int. Cl. G21F 5/00

(52) U.S. Cl. 277/314

(57) ABSTRACT

The invention relates to mineral surface and intermediate sealing systems for waste tips or for the safeguarding of old contaminated sites, using industrial waste substances, and to a method of producing, preparing and installing them, to their use in recultivation layers and to a method of producing them, the industrial waste substances being used as substitute building materials in mineral sealing systems or recultivation layers, preferably while using bentonite-bonded used sands or powders from foundries and/or clarification slurries.

In the mineral sealing layer for waste tips or for covering old contaminated sites and the method of producing it, natural earth building materials are replaced without the properties of the sealing substances being adversely affected. The advantage of the invention is that in the case of the mineral waste-tip sealings described according to the invention while using suitable water-absorptive additives, a mineral sealing material is produced which has better results with respect to the susceptibility to fissuring and the k-values Man is the case with the standard systems.

The invention relates to mineral surface and intermediate sealing systems for waste tips and the safeguarding of old contaminated sites using industrial waste substances, and to a method of producing, preparing and installing them, to their use in recultivation layers and to a method of producing them, the industrial waste substances being used as substitute building materials in mineral sealing systems or recultivation layers, preferably whilst using bentonite-bonded used sands or powders from foundries and/or clarification slurries.

A method is disclosed according to the invention in the publication WO 89 01547 A1, which is formed for sealing soil formations and in particular for forming waste tips by means of dried clarification and polluted-water slurries with a dry-substance content of ≦70%, other dried additives, powdered water glass and soft-gel formers. The drawback of this method is that the sealing systems comprising waste substances and recycling materials and treated with water glass require the use of expensive gel formers in order to reduce the permeability to water.

It is known from the prior art that laboratory and practical tests have been carried out by water-glass treatment of clarification-slurry mixtures which resulted in the formation of mineral sealings. An essential pre-condition for water-glass treatment is a mixture which is graded in terms of its grains and adequately aqueous and which is still capable of being compressed per se and thus capable of being sealed.

The publication DE 195 40 387 C2 discloses a method of producing multi-mineral sealings in which the high-grade, natural, argillaceous, silty, arenaceous and gritty earth building materials are replaced in part by cheap substitute building materials, such as bentonite-containing used sands from foundries and foundry slags.

According to the Technical Instructions (TI) urban waste is prescribed:

producing a combination sealing from a plastics-material sealing strip (PSS) and mineral barriers in accordance with the multiple-barrier concept for special and urban waste for above-ground waste tips.

according to DIN [German Industrial Standard] 18 123 the proportion of the finest gains (<0.002 mm) has to amount to at least 20%.

the water-permeability coefficients (k-values) amount to k≦5×10⁻¹⁰ m/s for base sealings and to k≦5×10⁻⁹ m/s for surface sealings.

The object of the invention is to test the use of substitute building materials in a mineral sealing layer for waste-tip coverings and intermediate coverings, coverings of old contaminated areas and recultivation layers and to provide a method of producing them, in which the natural argillaceous, silty, arenaceous and gritty earth building materials are replaced in part by cheap substitute building materials, without the properties of the sealing substances or the recultivation layer being adversely affected. The values of k≦5×10⁻⁹ m/s required in the mineral sealing have to be maintained.

The object is attained according to the invention by the features set out in claims 1 and 2. Preferred further developments of the invention are set out in the respective Sub-Claims.

The advantages of the invention are that with mineral surface coverings and intermediate coverings and/or recultivation layers the natural argillaceous, silty, arenaceous and gritty earth building materials are replaced in part by cheap substitute building materials, such as bentonite-bonded used sands or powders from foundries, or suitable contaminated polluted-water slurries and/or clarification slurries, without the properties of the sealing substances or the recultivation layer being adversely affected, the properties of the mineral sealing materials being considerably improved with respect to their susceptibility to fissuring as compared with the standard systems and the k-values being not exceeded.

As a result of the mineral sealings produced with bentonite-bonded used sands or powders from foundries, waste-tips can be safeguarded in an inexpensive manner and the encapsulation process of old contaminated areas can be carried out in a more rational manner. As a result of the additional use of suitable contaminated polluted-water slurries and/or clarification slurries in conjunction with bentonite-bonded used sands or powders from foundries, recultivation soils for waste-tip coverings can be produced in an inexpensive manner. The powders substances used are evaluated in terms of material, talking into consideration environmentally harmful parameters, the mineral sealings produced in this way having a long-term resistance when traversed by contaminated water.

The starting point of the investigation has been suitable bentonite-bonded used sands or powders from foundries as a substitute building material in mineral surface sealings of a waste tip. Bentonite-bonded used sands from foundries and bentonite-bonded powders from foundries have been regarded as being equivalent, since they are the same in their properties. The powders are only finer in their grading with respect to their grains. It is also possible to use a mixture of bentonite-bonded used sands from foundries and bentonite-bonded powders from foundries. The bentonite contained in the used sand from foundries is affected thermally in the casting process and has special properties which are displayed in an increased water-absorption capacity which can only be established, however, with a time delay.

The soil-mechanical investigations show that with respect to their sealing properties the bentonite-bonded used sands or powders from foundries meet the demands of mineral surface sealings of waste tips. The used sand from foundries essentially consists of fine quartz sand with a closely graded granulation range comprising bituminous-coal formers as a mineral phase and bentonite from foundries. In their grain-size distribution these waste substances are similar to loess soil in the range of medium to coarse silt. The bituminous-coal former is present in from 3 to 10% proportion by weight in the mixture of used sand from foundries.

It is important to establish that an organic carbon is involved here, which, although adversely affecting the annealing loss, does not have a negative effect on the sealing properties as is the case with organic constituents or other organic carbons.

The bentonite content in the used sand from foundries amounts to between 3 and 15% proportion by weight. The mineral analysis of the activated foundry bentonite has a proportion of montmorillonite of over 70% proportion by weight. Further accompanying minerals are: quartz, calcite, dolomite and feldspar. The annealing loss of the foundry bentonite cannot be attributed to burnt organic material, since the intercalated water in the lattice structure of the bentonite is released only at approximately 500° C.

The staring point of further investigations has been suitable polluted-water slurry and/or clarification slurries which have been contaminated and which have at least 30% dry residue (DR). A mechanical preliminary desiccation of the polluted-water slurry and/or clarification slurry, for example by chamber filter presses, screen-belt dryers or centrifuges, is absolutely necessary. The concentrated clarification slurry can be desiccated to from 18 to 30% DR by polymer conditioning by means of belt filter presses or centrifuges. An increased degree of desiccation can be achieved by means of chamber filter presses by the use of metallic-salt or polymer conditioning. In this case the average desiccability of from 28 to 38% DR can be achieved. If lime is additionally used as an additive, a desiccation of from 35 to 45% DR is possible. As a result of the mechanical desiccation the contact and capillary water of the clarification slurry can largely be removed. The absorption water and inherent moisture can only be removed by drying (up to approximately 95% DR). Treatment at <30% DR is not possible on account of the pulpy consistency. If the content of charging water is exceeded, optimum compression is not possible.

According to the invention, after the desiccation of the polluted-water or clarification slurry by machine, dry bentonite-containing used sand and/or powder from foundries at from 5 to 35% by weight and with a bentonite content of from 3 to 15% by weight can advantageously be mixed in at the clarification plant or other preparation plants for subsequent treatment. The high degree of water permeability (approximately from 60 to 100%) of these waste substances reduces the water content of the clarification slurry by approximately 10 to 20% in the case of the preferred addition of 10% by weight dry bentonite-containing used sands and/or powders from foundries. It is then possible to dispense with an admixture of lime.

The fibrous structure of the polluted-water slurry and/or clarification slurry, which consists of a slurry/sand mixture with a relatively high water-retention capacity, displays a considerable improvement with respect to the susceptibility to cracking as compared with the conventional standard sealing systems with clay and argillaceous loam.

It is known from the state of the art (DE 195 40 387 C2) that bentonite-containing used sands or powders from foundries have good sealing properties but are also susceptible to erosion in mineral sealing systems.

This drawback is counteracted by the use of a protection and drainage mat 3 and the plastics-material sealing strip 4 (PSS), which are known from the prior art.

The use of mineral waste-tip surface sealings and intermediate sealings has essentially the principal object of ensuring that the surface waste-tip water does not penetrate into the body of the waste-tip. No more contaminated water is therefore formed, which would have to be removed at a considerable cost. The said pre-conditions are met by the bentonite-containing used sands or powders from foundries, with an optimum charging water content of from 5 to 35% proportion by weight. The water-permeability coefficients “k” of the used sand or powder from foundries stored moist for different periods of time meet the bandwidth of the charging parameters in accordance with DIN 18130, which are permissible in waste-tip construction. This is present in the range of 97% of the simple Proctor density on the wet side of the Proctor curve over 100% of the Proctor density with an optimum water content up to 97% of the Proctor density on the dry side. The k-values established are as set out in the following, at from k=1.6×10⁻¹¹ m/s to k=3.2×10 ₋₁₀ m/s throughout which are below the value of k≦5×10⁻⁹ m/s permissible in accordance with the legal provisions for mineral surface coverings.

The use of mineral waste-tip sealings has essentially two main objects, which consist in the RETENTION OF POLLUTANTS AND SEALING (of conventional water reservoirs). A considerable sealing effect is achieved when a maximum or optimum packing density occurs with the smallest possible pore volume of the sealing material. The said preconditions are achieved according to the invention in terms of soil mechanics.

The structure of the bentonite-bonded used sand from foundries and bentonite-bonded powder from foundries with a relatively high water-retention capacity and SiO₂ content has major advantages in terms of the susceptibility to cracking as compared with conventional standard sealing systems with clay and argillaceous loam.

It is generally known that in the case of mineral soils, in particular clays, even with slight deformation (tensile stress) and even with slight changes in the water content of Δw=1%, cracks are formed and thus adversely affect the sealing effect.

The invention can be applied to surface and intermediate sealing systems for waste tips of Waste-Tip Class I: (single-substance waste tips, excavated waste); Waste-Tip Class II: (domestic-refuse urban waste); and Waste-Tip Class III: (special waste), as well as for safeguarding old contaminated sites and for use in recultivation layers.

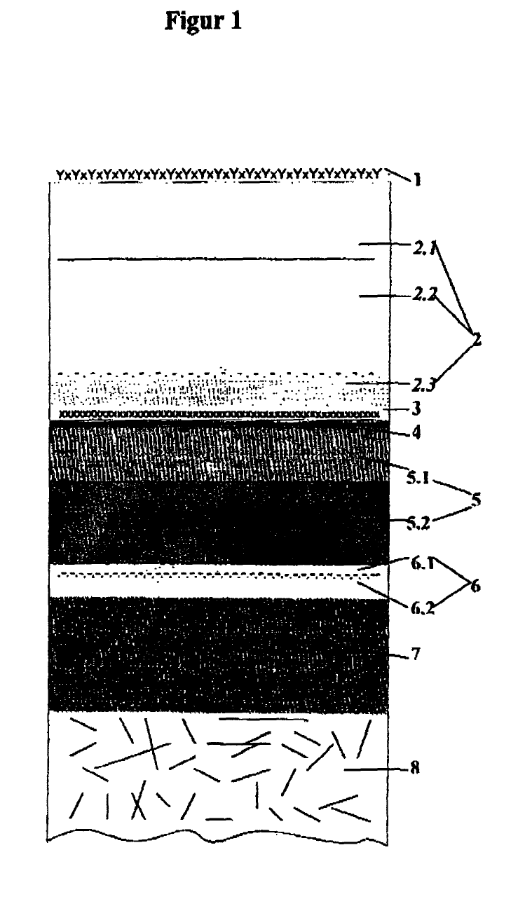

The invention is explained with reference to FIG. 1 as a surface-sealing system, which shows:

a vegetation layer 1, comprising seeded grass as a protection from erosion,

a recultivation layer 2, comprising water-management layers which, with a total layer thickness of from 0.7 m to 2.0 m. In principle this layer has the object—in conjunction with the vegetation—of evapotranspiration of as great a part as possible of the penetrating rainwater and of the supply of the non-absorptive proportion to the sealing element without damage. In addition, the water-management layer should be arranged in such a way that optimum growth conditions are available for the vegetation. In addition, it has to protect the sealing element from the action of roots and frost. The recultivation layer is therefore divided into layers with different water permeabilities,

into a recultivation layer 2.1, which should be regarded as topsoil or a vegetation layer and should be compared with a strongly argillaceous silt with respect to the nature of the soil, with a water permeability from k=4×10⁻⁶ m/s to k=5×10⁻⁷ m/s, comprising excavated argillaceous, silty soil of from 60 to 80% by weight, having admixed therewith from 10 to 20% by weight of bentonite-bonded used sands or powders from foundries and from 10 to 20% by weight of suitable contaminated polluted-water slurries and/or clarification slurries which should not be excessively compressed, in order to prevent the formation of macropores by dry cracks, with a layer thickness proportion of from 45 to 50% of the total layer thickness of the recultivation layer 2, and

into a recultivation layer 2.2 which at the same time has the function of a water-management layer and at the same time as root soil with a water permeability (from k=5×10⁻⁸ m/s to k=8×10⁻⁸ m/s) comprising a soil excavation of a slightly loamy sand with a proportion of from 45 to 70% by weight having admixed therewith from 20 to 35% by weight of the bentonite-bonded used sands or powders from foundries and from 10 to 20% by weight of suitable contaminated polluted-water slurries and/or clarification slurries to form from 40 to 45% by weight of the total layer thickness of the recultivation layer 2, as well as

a recultivation layer 2.3 as a root barrier and a simultaneous desiccation layer with a higher water permeability (from k=5×10⁻² m/s to k=5×10⁻⁴ m/s) comprising a weak coarse gravel and/or highly regenerated used sand from foundries with a very slight proportion of bentonite or a synthetic-resin-bonded used sand from foundries, foundry slags and/or BRR material, with a layer-thickness proportion of from 5 to 15% of the total layer thickness of the recultivation layer 2, as well as

a protective and drainage mat 3 (known from the prior art),

a plastics-material sealing strip (PSS) 4 (known from the prior art),

a mineral sealing layer 5 comprising bentonite-bonded used sand from foundries and/or bentonite-bonded powder from foundries with a layer thickness of from 0.2 m to 0.7 m which is set at a assembly-water content of from 5 to 35%, preferably 14.5%, or silty, argillaceous excavated waste; silty clays; recycling material from rubble; grit-sand mixtures as a supporting structure, in a grin size of from 0 to 32 mm; dry bentonite-containing used sand or powder from foundries as a filler with a partial sealing effect on account of the bentonite (bentonite content approximately from 3 to 15% by weight); and/or contaminated clarification slurry—subsequently treated with lime and/or with used sand or powder from foundries—with a DR of from 35 to 60% from a clarification plant, which clarification slurry meets the clarification-slurry regulation and is optionally installed separately in two layers, the layer 5.2 consisting of a silty, argillaceous earth building material which can be satisfactorily compressed; and/or silty clays as a sealing and plasticizing substance, and the layer 5.1 consisting of bentonite-bonded used sand from foundries and/or bentonite-bonded powder from foundries. An additional separating fleece is not required between the layers 5.1 and 5.2. The layer thicknesses can be selected in a variable manner, depending upon the quantities of material present. This combined sealing-layer variant has the advantage hat the layer 5.1 acts as a self-sealing layer if stress cracks occur in the layer 5.2. A assembly-water content of from 8 to 30%, preferably of 14.5%, is set.

a gas-permeable layer 6, with a layer thickness of from 30 to 40 cm, which is divided into

the covering of the gas-permeable layer 6.1, consisting of a mineral filter material in a grain size of from 0 to 8 mm, such as domestic-refuse incineration slag (DRI slags) and/or building-rubble recycling material (BRR material) with a layer thickness of from 5 to 30% proportion of the total layer thickness of the gas-permeable layer 6, and

the gas-permeable layer 6.2 with a grain size of from 4 mm to 52 mm consisting of recycling ballast from track installations and/or broken foundry slag and/or DRI slags and/or BRR material with a layer thickness of from 70 to 95% (proportion of the total layer thickness of the permeable layer 6)

and the profiling layer 7, with a variable layer thickness of foundry residues, such as bentonite-bonded used sand from foundries and/or bentonite-bonded powder from foundries, foundry slags, and/or BRR material mixed with ferruginous filter dust from iron or steel foundries at from 5 to 40% by weight, and from 60 to 95% by weight of BRR material with a grain size of from 0 to 32 mm,

which are coated on the body of the refuse 8.

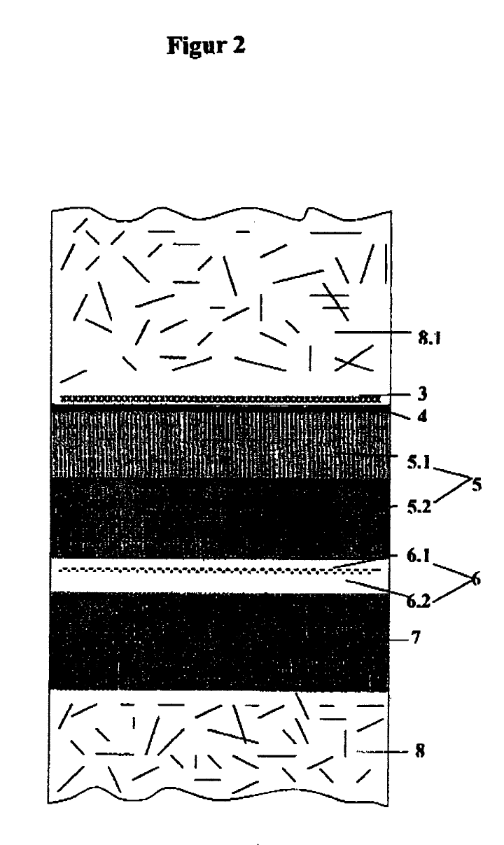

An intermediate covering as shown in FIG. 2 is produced with the same layer structure, except for the fact that the vegetation layer 1 and the recultivation layer 2 are absent.

This layer structure as shown in FIG. 1 and FIG. 2 results in the following advantages according to the invention:

1. The recultivation layer 2.1, with a water permeability of from k=4×10⁻⁶ m/s to k=5×10⁻⁷ m/s, performs the task of a vegetation layer, and the slight compression ensures the absorption of water and thus the availability of water for the settled vegetation to an excellent degree. Because of the additional use of clarification slurry, nutrients are supplied to the recultivation soil so that inferior earth building materials from building-site excavation can also be used.

2. The recultivation layer 2.2 is formed in the lower region as a water-management layer which at the same time has the function of root soil and is installed compressed with a water permeability of from k=5×10⁻⁸ m/s to k=8×10⁻⁸ m/s. This layer performs two essential tasks in that it acts as a water reservoir and supplies this stored water to the plants again at times of low rainfall. This layer should in no case achieve valuable k-values of <5×10⁻⁹ m/s, since otherwise water-logging will occur. As a result of the additional use of bentonite-bonded used sand from foundries and clarification slurry, nutrients are supplied to the recultivation layer, so inferior loamy-argillaceous earth building materials from building-site excavation can also be used.

3. The recultivation layer 2.3 is installed in the lowest region (resting on the protection and drainage mat) with a higher water permeability of from k=5×10⁻² m/s to k=5×10⁻⁴ m/s. It acts as an additional desiccation layer and as a root barrier for the subsequent sealing elements. This layer structure has the advantage that in the long term a water-conveying layer is formed which resembles an underground water conduit.

4. The laying of the PSS 4 does not require any special protection layers and can take place directly on the mineral scaling 5.

5. On account of the dry used sand from foundries as supplied, in the mineral sealing 5 the installation is not as susceptible to the weather as in the case of natural clays or silts.

6. It is possible to dispense with an additional protection fleece between the mineral sealing 5 and the gas-permeable layer 6, since this functional task is performed by the covering of the gas-permeable layer 6.1.

7. The profiling layer 7, of BRR material mixed with ferruginous filter dust, forms an excellent resistant support for the further structure of the entire surface sealing when water is added.

8. The mixture of the profiling layer 6, of BRR material with ferruginous filter dust, is also suitable in road building during the entire construction procedure and during the operation of the waste tip. In this case layer thicknesses of from 0.1 m to 0.5 m are required, which are installed by means of a crawler vehicle and are compressed by a smooth-surface roller. Spraying water by means of water-tank cars prevents the formation of dust after charging. As a result of rainwater this mixture is consolidated and hardened, and it has a high degree of resistance and only slight erosion characteristics.

The method of producing a mineral surface and intermediate sealing system for waste tips, coverings of old contaminated sites and recultivation layers, has the following components:

the recultivation layer 2, with a total layer thickness of from 0.7 to 2.0 m, comprising

the recultivation layer 2.1 (from 45 to 50% of the total layer thickness of 2), comprising

dry bentonite-containing used sand or powder from foundries (bentonite content of from 3 to 15% by weight) of from 10 to 20% by weight, preferably 15% by weight,

contaminated polluted-water slurries and/or clarification slurry subsequently treated with lime and/or used sand or powder from foundries, with DR of from 35 to 60%, which meets the clarification-slurry regulation, as a nutrient, of from 10 to 20% by weight, preferably 15% by weight,

and an excavated argillaceous-silty soil, low in humus or nutrients, of from 60 to 80% by weight, preferably 70% by weight,

and the recultivation layer 2.2 (from 40 to 45% of the total layer thickness of 2), comprises

dry, bentonite-containing used sand or powder from foundries (bentonite content from 3 to 15% by weight) with from 20 to 35% by weight, preferably 25% by weight

contaminated polluted-water slurries and/or clarification slurry subsequently treated with lime and/or used sand or powder from foundries, with DR of from 35 to 60%, which meets the clarification-slurry regulation, as a nutrient, of from 10 to 20% by weight, preferably 15% by weight,

and a slightly loamy-argillaceous soil excavation, low in humus or nutrients, of from 45 to 70% by weight, preferably 60% by weight, and

the recultivation layer 2.3 (from 5 to 15% of the total layer thickness of 2), comprises

a mixture of dry, highly regenerated used sand from foundries with a very low bentonite content and/or a synthetic-resin-bonded used sand from foundries of from 20 to 40% by weight, preferably 30% by weight

a granular soil excavation, slightly rich in humus or nutrients, of from 20 to 70% by weight, preferably 55% by weight, and

foundry slags BRR material in sizes of from 0 to 32 mm of from 10 to 20%, by weight, preferably 15% by weight,

the mineral sealing layer 5, with a total layer thickness of from 20 to 70 cm comprises,

bentonite-bonded used sand or powder from foundries mixed 100% by weight with water and a assembly-water content of from 5 to 35% proportion by weight, or

a mixture of from 25 to 50% by weight, preferably 40% by weight, of excavated silty, argillaceous soil; silty clays; building-rubble recycling material; grit-sand mixtures as a support structure, of from 0 to 32 mm in grain size, from 25 to 50% by weight, preferably 40% by weight, of dry bentonite-containing used sand or powder from foundries as a filler with a partial sealing effect as a result of the bentonite (bentonite content approximately from 3 to 15% by weight), from 5 to 40% by weight, preferably 20% by weight, of contaminated clarification slurry—subsequently, treated with lime and/or with used sand or powder from foundries—with a DR of from 35 to 60% from a clarification plant, which clarification slurry meets the clarification-slurry regulation, as a sealing and plasticizing substance. A assembly-water content of from 8 to 30%, preferably 14.5%, is set, or

the mineral sealing layer 5 comprising the layer 5.2, which is built up from a satisfactorily compressible silty, argillaceous earth building material; and/or silty clays as a sealing and plasticizing substance and the layer 5.1 consisting of bentonite-bonded used sand from foundries and/or bentonite-bonded powder from foundries,

for the gas-permeable layer 6 with a total layer thickness of from 30 to 40 cm consisting of

the gas-permeable layer 6.1 (from 5 to 30% of the total layer thickness of 6), with a granulation distribution of from 0 to 8 mm, DRI slag and/or foundry slags in the grain-size range of from 0 to 8 mm with 100% proportion by weight is used,

and the gas-permeable layer 6.2 (from 70 to 95% of the total layer thickness of 6), with a granulation distribution of from 4 to 56 mm, DRI slag and/or foundry slags in the grain-size range of from 4 to 52 mm with 100% proportion by weight is used,

for the profiling layer 7, which is variable in the layer thickness, and consists of from 60 to 95% by weight of BRR material and from 5 to 40% by weight of ferruginous filter dust.

These materials are applied to the body 8 of the waste tip.

In addition, for road construction in the terrain of the waste tip, a material can be used which consists of from 60 to 95% by weight of BRR material and from 5 to 40% by weight of ferruginous filter dust.

These charging substances, apart from the gas-permeable layer 6, have to be mixed homogeneously in a stationary mixing plant by means of positive mixers, with the addition of the necessary proportion of water, until the optimum content of charging water is set. The metering of the various materials takes place in the mixing plant with charging boxes and weighing belts. The mixed material is then applied in layers in the construction area and is compressed to the desired density by a smooth-surface roller.

A further possibility of homogeneous mixing can take place directly at the construction area. In this case the metering is carried out by a precise application in layers (with the aid of an all-round laser ±1 cm) of the materials to be mixed and by a precise setting of the cutting depth of a high-speed construction cutter. The prepared construction area is then cut though with a heavy construction cutter, optionally with the addition of water, until the optimum content of charging water is set, the cutting depth being set at approximately 25 cm. Prior to a further cutting procedure the pre-mixed material is pre-compressed with a smooth-surface roller and cut, in order to achieve a far-reaching homogenization. After that, the mixed material is compressed in layers to the desired density with a smooth-surface roller.

Reference Numerals Used

1. vegetation layer as erosion protection

2. recultivation soil

2.1. recultivation soil, vegetation layer

2.2. recultivation soil, water-management layer

2.3. recultivation soil, desiccation layer

3. protection and drainage mat

4. plastics-material sealing strip (PSS)

5. mineral sealing layer

5.1. bentonite-bonded used sand from foundries and/or bentonite-bonded powder from foundries

5.2. satisfactorily compressible silty, argillaceous earth building material; silty clays as a sealing and plasticizing substance

6. gas-permeable layer

6.1. gas-permeable layer with a grain size of from 0 to 8 mm

6.2. gas-permeable layer with a grain size of from 4 to 52 mm

7. profiling layer

8. waste-tip material between a surface or intermediate sealing and a base sealing

8. waste-tip material between a surface sealing and an intermediate sealing

Claims:

1. Mineral surface sealing systems for waste tips or for the safeguarding of old contaminated sites, using industrial waste substances, wherein a profiling layer is applied to the body of the waste tip, in which a gas-permeable layer and a mineral sealing layer are applied over the profiling layer, after which a plastics-material sealing strip is laid, and the laying of a protection and drainage mat takes place on the latter, with a recultivation layer and a vegetation layer situated thereabove.

2. Mineral intermediate sealing systems for waste tips or for the safeguarding of old contaminated sites, using initial waste substances, wherein a profiling layer is applied to the body of the waste tip, in which a gas-permeable layer and a mineral sealing layer are applied over the profiling layer, after which a plastics-material sealing strip is laid, and the laying of a protection an drainage mat takes place on the latter, with a waste-tip material situated thereabove.

3. Mineral sure sealing systems for waste tips or for the safeguarding of old contaminated sites, using industrial waste substance, according to claim 1, wherein the recultivation layer with a total layer thickness of from 0.7 m to 2.0 m, has an upper recultivation layer at from 45 to 50% of the total layer thickness of the recultivation layer, as a water-permeable vegetation layer with a water permeability in the range at from k=4×10⁻⁸ m/s to k=5×10⁻⁷ [m/s] and a lower recultivation layer with a water permeability from 40 to 45% of the total layer thickness of the recultivation layer, as a water-management layer with a water permeability from k=5×10⁻⁸ m/s to k=8×10⁻⁸ m/s, and a lowest recultivation layer from 5 to 15% of the total layer thickness of the recultivation layer, as a desiccation layer and a root barrier with a water permeability from k=5×10⁻² m/s to k=5×10⁻⁴ m/s, which are produced and installed separately.

4. Mineral surface sealing systems for waste tips or for the safeguarding of old contaminated sites, using industrial waste substances, according to claim 1, wherein a recultivation layer comprises the upper recultivation layer of dry bentonite-containing used sand and/or powder from foundries having a bentonite content of from 3 to 15% by weight, with from 10 to 20% by weight, preferably 15% by weight, of contaminated polluted-water slurries and/or clarification slurry subsequently treated with lime and/or used sand or powder from foundries, with DR of from 35 to 60% as a nutrient, at from 10 to 20% by weight, preferably 15% by weight, and an argillaceous-silty soil excavation, slightly rich in humus or nutrients, at from 60 to 80% by weight, preferably 70% by weight, and the lower recultivation layer comprises a mixture of dry, highly regenerated used sand and/or powder from foundries with a very low bentonite content at from 20 to 35% by weight, preferably 25% by weight, contaminated polluted-water slurries and/or clarification slurry subsequently treated with lime and/or used sand or powder from foundries, with DR of from 35 to 60%, as a nutrient of from 10 to 20% by weight, preferably 15% by weight, and a slightly loamy-argillaceous soil excavation, low in humus or nutrients, at from 45 to 70% by weight, preferably 60% by weight, and the lowest recultivation layer comprises a mixture of dry, highly regenerated used sand from foundries with a very low bentonite proportion and/or a synthetic-resin-bonded used sand from foundries at from 20 to 40% by weight, preferably 30% by weight and an excavated granular soil, slightly rich in humus or nutrients, at from 20 to 70% by weight, preferably 55% by weight, and foundry slags and/or BRR material in grain sizes of from 0 to 32 mm with from 10 to 20% by weight, preferably 15% by weight.

5. Mineral surface and intermediate sealing systems for waste tips or for the safeguarding of old contaminated sites, using industrial waste substances, according to claim 1, wherein the mineral sealing layer has a layer thickness of from 20 to 70 cm, and consists of bentonite-bonded used sand or powder from foundries having a bentonite content from 3 to 15% by weight, mixed 100% by weight with water and an assembly-water content of from 5 to 35% proportion by weight, and a k-value of 5×10⁻⁹ m/s.

6. Mineral intermediate sealing systems for waste tips or for safeguarding of old contaminated sites, using industrial waste substances, according to claim 2, wherein the mineral sealing layer has a layer thickness of from 20 to 70 cm, and consists of bentonite-bonded used sand or powder from foundries having a bentonite content from 3 to 15% by weight, mixed 100% by weight with water and an assembly-water content of from 5 to 35% proportion by weight, and a k-value of 5×10⁻⁹ m/s.

7. Mineral surface sealing systems for waste tips or for safeguarding of old contaminated sites using industrial waste substances, according to claim 1, wherein the mineral sealing layer has a layer thickness of from 20 to 70 cm, and consists of a mixture of silty, excavated argillaceous soil; silty clays; building-rubble recycling material; and/or grit-sand mixtures as a support structure, at from 25 to 50% by weight, preferably 40% by weight, with a grain size of from 0 to 32 mm, and dry bentonite-containing used sand or powder from foundries as a filler with a partial sealing effect as a result of the bentonite having a bentonite content approximately from 3 to 15% by weight, at from 25 to 50% by weight, preferably 40% by weight, and contaminated clarification slurry, which has been subsequently treated with lime and/or with used sand or powder from foundries with DR of from 35 to 60% from a clarification plant, which clarification slurry meets the clarification-slurry regulation, as a sealing and plasticizing substance at from 5 to 40% by weight, preferably 20% by weight, an assembly-water content of from 8 to 30%, preferably 14.5%, being set.

8. Mineral intermediate sealing systems for waste tips or for safeguarding of old contaminated sites, using industrial waste substances, according to claim 2, wherein the mineral sealing layer has a layer thickness of from 20 to 70 cm, and consists of a mixture of silty, excavated argillaceous soil; silty clays; building-rubble recycling material; and/or grit-sand mixtures as a support structure, at from 25 to 50% by weight, preferably 40% by weight, with a grain size of from 0 to 32 mm, and dry bentonite-containing used sand or powder from foundries as a filler with a partial sealing effect as a result of the bentonite having a bentonite content approximately from 3 to 15% by weight, at from 25 to 50% by weight, preferably 40% by weight, and contaminated clarification slurry, which has been subsequently treated with lime and/or with used sand or powder from foundries with DR of from 35 to 60% from a clarification plant, which clarification slurry meets the clarification-slurry regulation, as a sealing and plasticizing substance at from 5 to 40% by weight, with a grain size of from 0 to 32 mm, and dry bentonite-containing used sand or powder from foundries as a filler with a partial sealing effect as a result of the bentonite having a bentonite content approximately from 3 to 15% by weight, at from 25 to 50% by weight, preferably 40% by weight, and contaminated clarification slurry, which has been subsequently treated with lime and/or with used sand or powder from foundries with DR of from 35 to 60% from a clarification plant, which clarification slurry meets the clarification-slurry regulation, as a sealing and plasticizing substance at from 5 to 40% by weight, preferably 200% by weight, an assembly-water content of from 8 to 30%, preferably 14.5%, being set.

9. Mineral surface sealing systems for waste tips or for the safeguarding of old contaminated sites, using industrial waste substances, according to claim 1, wherein the mineral sealing layer has a layer thickness of from 20 cm to 70 cm and is installed separately in two layers, in which the first layer consists of bentonite-bonded used sand from foundries and/or bentonite-bonded powder from foundries and the second lay consists of a silty, argillaceous earth building material which can be satisfactorily compressed; and/or silty clays as a sealing and plasticizing substance.

10. Mineral intermediate sealing systems for waste tips or for safeguarding of old contaminated sites, using industrial waste substances, according to claim 2, wherein the mineral sealing layer has a layer thickness of from 20 cm to 70 cm and is installed separately in two layers, in which the first layer consists of bentonite-bonded used sand from foundries and/or bentonite-bonded powder from foundries and the second layer consists of a silty, argillaceous earth building material which can be satisfactorily compressed; and/or silty clays as a sealing and plasticizing substance.

11. Mineral surface and intermediate sealing systems for waste tips or for the safeguarding of old contaminated sites, using industrial waste substances, according to claim 1 wherein after the desiccation of the polluted-water slurry and/or clarification slurry by machine, dry bentonite-containing used sand and/or powder from foundries at from 5 to 35% by weight and with a bentonite content of from 3 to 15% by weight is mixed in.

12. Mineral intermediate sealing systems for waste tips or for safeguarding of old contaminated sites, using industrial waste substances, according to claim 2, wherein after the desiccation of the polluted-water slurry and/or clarification slurry by machine, dry bentonite-containing used sand and/or powder from foundries at from 5 to 35% by weight and with a bentonite content of from 3 to 15% by weight is mixed in.

13. Mineral surface and intermediate sealing systems for waste tips or for the safeguarding of old contaminated sites, using industrial waste substances, according to claim 1, wherein the gas-permeable layer, with a total layer thickness of from 30 to 40 cm, consists of an upper layer, consisting of a mineral filter material in a grain size of from 0 to 8 mm, such as domestic-refuse incineration slag (DRI slags) and/or building-rubble recycling material (BRR material) with a layer thickness of from 5 to 30% as a proportion of the total layer thickness of the gas-permeable layer, and a lower layer with a grain size of from 4 mm to 52 mm of recycling ballast from track installations and/or broken foundry slag and/or DRI slags and/or BRR material with a layer thickness of from 70 to 95% as a proportion of the total layer thickness of the gas-permeable layer.

14. Mineral intermediate sealing systems for waste tips or for safeguarding of old contaminated sites, using industrial waste substances, according to claim 2, wherein the gas-permeable layer, with a total layer thickness of from 30 to 40 cm, consists of an upper layer, consisting of a mineral filter material in a grain size of from 0 to 8 mm, such as domestic-refuse incineration slag (DRI slags) and/or building-rubble recycling material (BRR material) with a layer thickness of from 5 to 30% as a proportion of the total layer thickness of the gas-permeable layer, and a lower layer with a grain size of from 4 mm to 52 mm of recycling ballast from track installations and/or broken foundry slag and/or DRI slags and/or BRR material with a layer thickness of from 70 to 95% as a proportion of the total layer thickness of the gas-permeable layer.

15. Mineral surface and intermediate sealing systems for waste tips or for the safeguarding of old contaminated sites, using industrial waste substances, according to claim 1 wherein the profiling layer, with a variable layer thickness, consists of foundry residues, such as bentonite-bonded used sand from foundries and/or bentonite-bonded powder from foundries and/or foundry slags, and/or BRR material mixed with ferruginous filter dust at from 5 to 40% by weight from iron or steel foundries, and from 60 to 95% by weight of BRR material with a grain size of from 0 to 32 mm.

16. Mineral intermediate sealing systems for waste tips or for a safeguarding of old contaminated sites, using industrial waste substances, according to claim 2, wherein the profiling layer, with a variable layer thickness, consists of foundry residues, such as bentonite-bonded used sand from foundries and/or bentonite-bonded powder from foundries and/or foundry slags, and/or BRR material mixed with ferruginous filter dust at from 5 to 40% by weight from iron or steel foundries, and from 60 to 95% by weight of BRR material with a grain size of from 0 to 32 mm.

17. A method of producing, preparing and installing mineral surface and intermediate sealing systems for waste tips and the safeguarding of old contaminated sites whilst using industrial waste substances, according to claim 1, wherein the production of the mixture takes place in a stationary mixing plant by means of positive mixers, optionally with the addition of water is reached, until the optimum content of charging water is reached, the mixture then being applied in layers and being compressed to the desired density by a smooth-surface roller.

18. Mineral intermediate sealing systems for waste tips or for safeguarding of old contaminated sites, using industrial waste substances, according to claim 2, wherein wherein the production of the mixture takes place in a stationary mixing plant by means of positive mixers, optionally with the addition of water is reached, until the optimum content of charging water is reached, the mixture then being applied in layers and being compressed to the desired density by a smooth-surface roller.

19. A method of producing, preparing and installing mineral surface and intermediate sealing systems for waste tips and the safeguarding of old contaminated sites using industrial waste substances, according to claim 1, wherein the method is carried out at the construction area by a precise application in layers of the individual materials and then by cutting by means of soil cutters, optionally with the addition of water, until the optimum content of charging water is reached, and each layer is then compressed to the desired density with a smooth-surface roller.

20. Mineral intermediate sealing systems for waste tips or for safeguarding of old contaminated sites, using industrial waste substances, according to claim 2, wherein the method is carried out at the construction area by a precise application in layers of the individual materials and then by cutting by means of soil cutters, optionally with the addition of water, until the optimum content of charging water is reached, and each layer is then compressed to the desired density with a smooth-surface roller.

21. Ferruginous used sands or powders from foundries for road construction in the terrain of a waste tip, wherein a mixture of ferruginous used sand or powder from foundries at from 5 to 40% by weight and from 60 to 95% by weight of building rubble recycling material and water at from 5 to 20 litres per 100 kg of mixture, with a layer thickness of from 10 cm to 50 cm is installed by a crawler vehicle and compressed by a smooth-surface roller.
